(19) United States
(12) Patent Application Publication
(10) Pub. No.: US 2026/0346196 A1
(43) Pub. Date: Nov. 5, 2026

(54) APPARATUS AND CONTINUOUS PROCESS FOR THE CATALYTIC REMOVAL OF HYDROGEN SULFIDE FROM GASES

(71) Applicant: Council of Scientific & Industrial Research, New Delhi (IN)

(72) Inventors: Shubhangi Bhalchandra UMBARKAR, Pune (IN); Radhamonyammma Nandini DEVI, Pune (IN); Vipul Subhash PATIL, Pune (IN)

(21) Appl. No.: 19/488,999

(22) PCT Filed: May 30, 2024
(86) PCT No.: PCT/IN2024/050640

§ 371 Date: Dec. 1, 2025

(30) Foreign Application Priority Data
Jun. 2, 2023 (IN) 202311038418

(51) Int. Cl. B01D 53/86

(52) U.S. Cl. CPC B01D 53/8612; B01D 2255/20738; B01D 2255/705; B01D 2257/304; B01D 2258/025; B01D 2258/05

(57) ABSTRACT

The present invention relates to catalytic removal of H₂S gas from gaseous fluid stream. Specifically, the present invention relates to an apparatus/reactor for catalytic removal of H₂S gas and subsequently production of sulphur. More specifically, the present invention relates to a continuous process for removal of H₂S gas using the continuous process reactor system comprising treating H₂S gas containing stream with catalyst solution along with production of solid sulphur. Additionally, the present invention provides the process which is cost effective, easy to handle, high throughput, highly selective, safe and environment friendly.

### FIELD OF THE INVENTION

The present invention generally relates to catalytic removal of H₂S gas from gaseous fluid stream. Specifically, the present invention relates to an apparatus/reactor for catalytic removal of H₂S gas and subsequently production of sulphur. More specifically, the present invention relates to a continuous process for removal of H₂S gas using said continuous process reactor system comprising treating H₂S gas containing stream with catalyst solution along with production of solid sulphur. Additionally, the present invention provides a cost effective, easy to handle, high throughput, highly selective, safe and environment friendly method for removal of H₂S gas, and subsequently production of sulphur.

### BACKGROUND OF THE INVENTION

H₂S removal is a key step in most of the chemical plants where natural gas combustion, methane combustion, coal gasification, crude oil combustion, bio gas purification etc. processes are involved.

In literature, three conventional types of processes for the removal of H₂S is there: a) three steps batch process where feed/stream is reacted with iron-based catalyst in single pot to obtain iron sulphides, which is then treated with oxygen gas to obtain H₂S and sulphur as solid, and finally the solid material is scrapped off (IN U.S. Pat. No. 233,617). This is hectic and tedious process as for all three steps require three different equipments/container, which is also time consuming and not preferable considering industrial bulk production; b) microbial enzymatic process where feed is treated with microbial culture and NaOH followed by fermentation/enzymatic cleavage under specific biotechnological conditions to remove H₂S. This is a very costly, laborious and tedious method which requires dedicated biological materials and reactor; and c) commercial process adopted in coal/steel industries where multiple temperatures/cooling cycles are done by treating methanol with feed at −30 C to remove H₂S.

More reports/patents are known in the literature, such as: U.S. Pat. No. 4,189,462 discloses a catalytic system which is very complex with multiple systems like FeCl₃+N₄ EDTA+Na₃ HEDTA+sorbitol+NaOH+Na₂CO₃. Along with FeCl₃, two chelating agents, out of which one is amine containing and other is polyhydroxy agents are used. During the continuous operations, intermittent addition of Na₂CO₃ was essential to maintain required PH. The catalyst (Fe) concentration is between 5 ppm to 5000 ppm. The ratio of chelating agent:Fe is in the range of 0.5-2:1 for amine containing chelate and 0.167:1 in case of polyhydroxy chelating agent. There are two different designs practiced in this patent: Design-1 offers absorption and activation in same reactor which ultimately creates an additional problem of contamination of H₂S free original gas stream with oxygen; and Design-2 offers absorption and activation in different reactors but the feed gas is provided through the venturi scrubber. It clearly indicates that the ratio of catalyst solution to feed gas is high because it has to pass through scrubber as well as venturi to suck the feed gas stream. CN102421507B discloses the use of a mixture of amine and phosphonic acid as adsorbent for H₂S. There is no conversion of H₂S to S. It is only adsorption of H₂S and desorption. There is no use of a catalyst in this method.

An article by “A. G. Georgiadis et al., Catalysts 2020, 10, 521” reports various adsorption technologies. It mentions various solid absorbers like zeolites where H2S is adsorbed and later desorbed. In few cases, in presence of moisture or O₂, the H2S is oxidatively converted to S but removal of solid S from solid adsorbent surely is a difficult task. Also, the adsorption is a much cost intensive process as compared to catalytic process as the adsorbent needs to be regenerated before the next cycle.

The aforesaid known/reported processes for the removal of H₂S are having following disadvantages: Adsorption based processes needs Zeolites/ZnO/other metal oxide adsorbents for the H2S removal but for the reactivation of these adsorbents, high temperature calcination is required which activate the adsorbents with the liberation of SO₂ gas in the atmosphere. Activation requires a high temperature which makes the process cost intensive. Series of activation and deactivation cycles reduces the adsorbent life. Biogas loss during activation cycles may occur as CH₄ may also have some adsorption tendency for few adsorbents.

Microbial based processes are also practiced for H₂S removal but these processes need circulation of NaOH followed by oxidation to recover the elemental Sulphur but this process requires more cost of operation and less separation efficiency for H₂S.

Therefore, there is an unmet need in the art to solve the aforementioned problems and provide cost effective, highly selective, environment friendly and safe continuous process for H₂S removal and where elemental sulphur can be collected as an additional product from the bio-gas stream.

### OBJECTIVES OF THE INVENTION

The main objective of the present invention is to provide catalytic removal of H₂S gas from gaseous fluid stream.

Another objective of the present invention is to provide an apparatus/reactor for catalytic removal of H₂S gas and subsequently production and separation of sulphur.

Yet another objective of the present invention is to provide a continuous process for removal of H₂S gas using said continuous process reactor system comprising treating H₂S gas containing stream with catalyst solution along with production of solid sulphur.

Still another objective of the present invention is to provide a cost effective, highly selective, environment friendly and safe continuous process for H₂S removal.

### SUMMARY OF THE INVENTION

The present invention relates to an apparatus for catalytic removal of H₂S gas and subsequently production of sulphur. Further, the present invention relates to a continuous process for removal of H₂S gas using said continuous process reactor system comprising treating H₂S gas containing stream with catalyst solution along with production and separation of solid sulphur.

In one aspect, the present invention provides a reactor system (100) for separation of H₂S gas and subsequent production of sulphur from feed or stream containing mixture of gases and H₂S, the reactor system (100) comprises:
a) a first compartment (110) comprises an inlet gas feed flow (130) containing said feed/stream, and plurality of horizontal grooves (112) with metal catalyst beds, to react H₂S gas of the feed/stream with the metal catalyst (170) to obtain H₂S free gas stream (170), and a metal sulfide;
b) the first compartment (110) is connected to a second compartment (120) for passing and treating the metal sulphide with air/oxygen in the second compartment (120) to obtain solid sulphur and spent catalyst; wherein the second compartment (120) comprises an inlet air flow (140);
c) filter press or gravity separation unit (190) connected with the second compartment (120) in order to separate the obtained solid sulphur (200); and
d) optionally the spent catalyst is fed back into the first compartment (110) from second compartment (120) via the filter press or gravity separation unit (190).

In an embodiment, said H₂S free gas stream (170) is removed from a top side of the first compartment (110).

In another embodiment, the first and second compartments (110) (120) have a length in the range of 0.1 to 2000 cm, and a diameter in the range of 0.01 to 110 cm.

The selection of a particular L/D ratio is the key aspect of the design as it plays a crucial role in retention time distribution inside the reactor which eventually affects the performance of the reactor.

In another embodiment, the horizontal grooves (112) are placed horizontally in a vertical shaped first compartment (110) with an angle in the range of 60° to 90°.

In another embodiment, a rate of the inlet gas flow (130) containing mixture of gases into the first compartment (110) is in the range of 0.1 to 600000 ml/min.

In another embodiment, a rate of the inlet air flow (140) into the second compartment (120) is in the range of 0.1 to 1000000 ml/min.

In another embodiment, the first compartment (110) and second compartment (120) is same or different, and are selected from the group consisting of a multi-phase co/counter current slurry flow reactor, a bubble column reactor, a slurry flow co/counter current multiphase reactor, a cascaded bubble column reactor, and a batch reactor.

In another aspect, the present invention provides a process for the separation of H₂S gas and subsequent production of sulphur from feed or stream containing mixture of gases and H₂S, the process comprising steps of:
i. passing the feed/stream via an inlet gas feed flow (130) into a first compartment (110) for treating and reacting with a metal catalyst (110) to obtain H₂S free gas stream (170), and a metal sulfide, wherein the metal catalyst is placed on plurality of horizontal grooves (112) beds in said first compartment (110);
ii. passing and treating said metal sulphide with air/oxygen in a second compartment (120) to obtain solid sulphur and spent catalyst followed by separating the obtained solid sulfur from filter press or gravity separation unit (190) connected with the second compartment (120); and
iii. optionally the spent catalyst is fed back into the first compartment (110) from second compartment (120) via said filter press or gravity separation unit (190).

In another embodiment, the feed/stream containing H₂S is selected from biogas, coal gas product/feeds, steel industry feeds and crude oil.

In another embodiment, the catalyst consists of a metal selected from transition metal and alkaline metal precursors, wherein said metal in the metal catalyst is selected from the group consisting of iron, tin, lead, copper, manganese, platinum, tungsten, nickel, palladium, chromium, cobalt, vanadium, titanium, tantalum, zirconium and molybdenum or mixtures thereof.

In another embodiment, the metal catalyst present in the first compartment is in an aqueous catalyst solution maintained at pH in the range of 7.0 to 9.0 by adding a hydroxide of an alkaline earth element selected from the group consisting of sodium, potassium, and magnesium.

In another embodiment, the metal catalyst solution comprises a metal chelate catalyst in an aqueous solution.

In another embodiment, the metal chelate is a transition metal salt of iron selected from the group consisting of a solution of sulfates, nitrates, thiosulfates, chlorides, acetates, oxalates and phosphates.

In another embodiment, the transition metal salt is chelated with di carboxylic acid, wherein the di-carboxylic acid is selected from the group consisting of succinic acid, malic acid, gluconic acid and oxalic acid.

In another embodiment, a concentration of the metal catalyst is in the range of 0.00001 mol. % to 50 mol. %.

In another embodiment, a concentration of H₂S obtained from said feed/stream containing mixture of gases and H₂S gas is in the range of 0.000001 vol. % to 100 vol. %.

In another embodiment, a temperature of the reactor is kept in the range of 25 °C to 80 °C.

In another aspect of the present invention, the multi-phase co/counter current slurry flow reactor is a continuous flow reactor.

In another aspect of the present invention, the metal chelate is a transition metal chelate of iron selected from the group consisting of a solution of sulfates, nitrates, thiosulfates, chlorides, acetates, oxalates and phosphates.

In another aspect of the present invention, the di carboxylic acid is selected from the group consisting of succinic acid, malic acid, gluconic acid and oxalic acid.

In another aspect of the present invention, the iron chelate catalyst has malic acid as chelating agent, wherein the ratio of malic acid:Fe is 3:1.

In another aspect of the present invention, the Fe catalyst concentration is in the range of 0.00001 mol. % to 50. mol. %.

In another aspect of the present invention, the feed containing H₂S concentration to be converted is in the range of 0.000001 vol. % to 100 vol. %.

In another aspect, the present invention provides a process which is cost effective, easy to handle, high throughput, highly selective, safe and environment friendly.

Various objects, features, aspects and advantages of the inventive subject matter will become more apparent from the following detailed description of preferred embodiments.

### BRIEF DESCRIPTION OF THE DRAWINGS

FIG. 1 illustrates Process Flow Diagram (PFD) for the catalytic separation of H₂S gas, removal of H₂S free gas, and subsequently sulfur production along with catalyst regeneration.

FIG. 2 illustrates the first compartment of the apparatus containing horizontal groove-like arrangement(s).

FIG. 3 illustrates the 3D Isometric view of the apparatus.

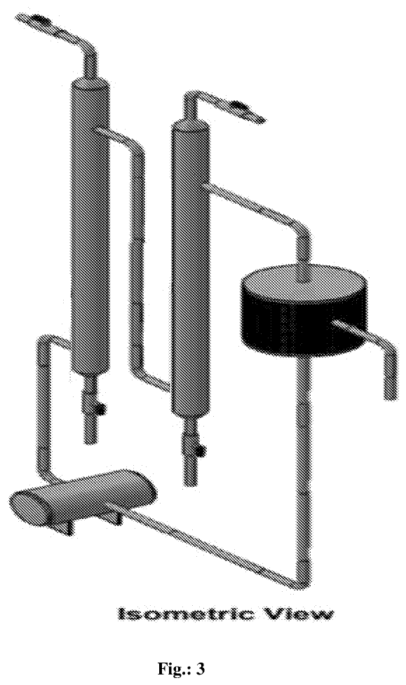

### DETAILED DESCRIPTION OF THE INVENTION

The following is a detailed description of embodiments of the disclosure. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Unless the context requires otherwise, throughout the specification which follow, the word “comprise” and variations thereof, such as, “comprises” and “comprising” are to be construed in an open, inclusive sense that is as “including, but not limited to.”

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description are approximations that can vary depending upon the desired properties sought to be obtained by a particular embodiment. In some embodiments, the numerical parameters should be constructed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The recitation of ranges of values herein is merely intended to serve as a shorthand method of referring individually to each separate value falling within the range. Unless otherwise indicated herein, each individual value is incorporated into the specification as if it is individually recited herein.

All processes described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

The headings and abstract of the invention provided herein are for convenience only and do not interpret the scope or meaning of the embodiments.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description that follows, and the embodiments described herein, is provided by way of illustration of an example, or examples, of particular embodiments of the principles and aspects of the present disclosure. These examples are provided for the purposes of explanation, and not of limitation, of those principles and of the disclosure.

It should also be appreciated that the present invention can be implemented in numerous ways, including as a system, a method or a device. In this specification, these implementations, or any other form that the invention may take, may be referred to as processes. In general, the order of the steps of the disclosed processes may be altered within the scope of the invention.

In a general embodiment, the present invention generally relates to catalytic removal of H₂S gas from gaseous fluid stream. Specifically, the present invention relates to an apparatus/reactor for catalytic removal of H₂S gas and subsequently production and separation of sulphur. Further, the present invention relates to a continuous process for removal of H₂S gas using said continuous process reactor system comprising treating H₂S gas containing stream with catalyst solution along with production and separation of solid sulphur.

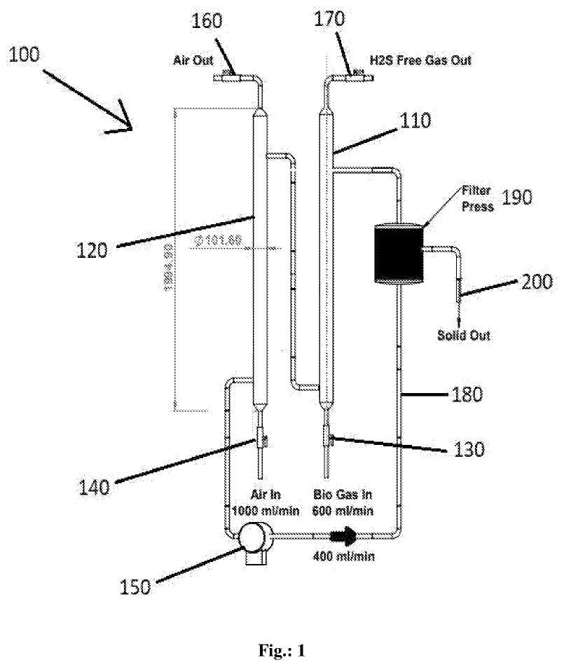

In an embodiment, the present invention provides an apparatus/reactor for the catalytic removal of H₂S gas and subsequently production of sulphur comprising of first compartment (110) of said reactor containing multiple horizontal groove like arrangements (112) with metal catalyst moving beds, to obtain feed with metal sulphides which subsequently treated with oxygen/air in parallel attached second compartment (120) of reactor to separate out solid sulphur (200) in spent stream using filter press/gravity separation (190) which may be flown back into first compartment (110) making it a continuous cycle/process as shown in FIG. 1. In another embodiment of the present invention, the cylindrical compartments (110) (120) of the reactor have the same dimensions, having length in the range of 0.1 to 2000 cm and diameter is in the range of 0.01 to 110 cm. Specifically, the length is in the range of 1 to 2000 cm or 2 to 2000 cm or 3 to 2000 cm or 4 to 2000 cm or 5 to 2000 cm or 10 to 2000 cm or 15 to 2000 cm or 20 to 2000 cm or 25 to 2000 cm or 50 to 2000 cm or 60 to 2000 cm or 75 to 2000 cm or 100 to 2000 cm or 125 to 2000 or 150 to 2000 cm or 175 to 2000 cm or 200 to 2000 cm or 250 to 2000 cm or 300 to 2000 cm or 350 to 2000 cm or 400 to 2000 cm or 450 to 2000 cm or 500 to 2000 cm or 550 to 2000 cm or 600 to 2000 cm or 650 to 2000 cm or 700 to 2000 cm or 750 to 2000 cm or 800 to 2000 cm or 850 to 2000 or 900 to 2000 cm or 950 to 2000 cm or 1000 to 2000 cm or 1100 to 2000 cm or 1200 to 2000 cm or 1300 to 2000 cm or 1400 to 2000 cm or 1500 to 2000 cm or 1600 to 2000 cm or 1700 to 2000 cm or 1800 to 2000 cm or 1900 to 2000 cm. Further, specifically the diameter is in range of 0.1 to 110 cm or 0.2 to 110 cm or 0.5 to 110 cm or 0.7 to 110 cm or 1 to 110 cm or 5 to 110 cm or 7.5 to 110 cm or 10 to 110 cm or 15 to 110 cm or 20 to 110 cm or 25 to 110 cm or 30 to 110 cm or 35 to 110 cm or 40 to 110 cm or 45 to 110 cm or 50 to 110 cm or 55 to 110 cm or 60 to 110 cm or 65 to 110 cm or 70 to 110 cm or 75 to 110 cm or 80 to 110 cm or 85 to 110 cm or 90 to 110 cm or 95 to 110 cm or 100 to 110 cm or 105 to 110 cm.

Preferably, the cylindrical compartments (110) (120) of the reactor have length in the range of 1900 to 1995 units and diameter of 90 to 105 units. More preferably, the cylindrical compartments (110) (120) of the reactor have length of 1994.90 units and diameter of 101.60 units.

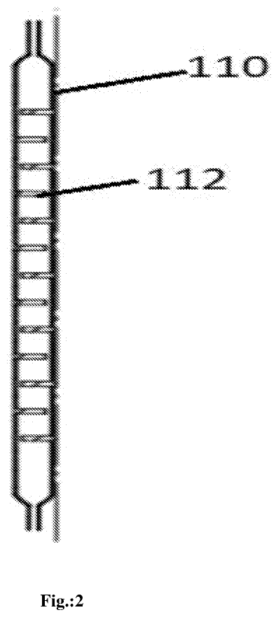

In another embodiment of the present invention, the horizontal groove-like arrangement(s) (112) as shown in FIG. 2 are having the same length and placed horizontally in the vertical shaped first compartment (110) of the reactor with 900 angles. Further, multiple horizontal groove like arrangements (112) are provided for the residing catalyst, reacting with vertical flow of H₂S containing stream or feed to have efficient retention time of feed to react with catalyst. Also, due to said horizontal groove like arrangements (112) in said reactor, the residence time is higher and better than conventional ones, wherein, the back pressure is higher due to said arrangements, which makes the contact between feed and catalyst efficient along with flow. Thus, the reactor internally provides a radial flow path which helps for maintaining required retention time for the reaction.

In another embodiment of the present invention, the circulation pump (150) is selected in such a way that it will provide optimum liquid retention time inside the reactor as well as the regeneration column with desired discharge head.

In another embodiment, the spent air/oxygen is discharged from the second compartment (120) via air out flow (160).

In another embodiment, the spent regenerated catalyst is fed back into the first compartment (110) from second compartment (120) via the filter press or gravity separation unit (190) through circulation pipe (180).

In another embodiment of the present invention, the concentration of catalyst in said catalyst bed(s) is in the range of 0.00001 mol. % to 99.99 mol. %.

Preferably, the concentration of catalyst in said catalyst bed(s) is in the range of 1-99 mol. % or 2-98 mol. % or 3-97 mol. % or 4-96 mol. % or 5-95 mol. % or 10-90 mol. % or 15-85 mol. % or 20-80 mol. % or 25-75 mol. % or 30-70 mol. % or 35-65 mol. % or 40-60 mol. % or 45-55 mol. %.

More specifically, the concentration of catalyst in said catalyst bed(s) is 0.0001 mol. % or 0.001 mol. % or 0.01 mol. % or 0.1 mol. % or 1 mol. % or 1.25 mol. % or 1.5 mol. % or 2 mol. % or 2.5 mol. % or 2.75 mol. % or 3 mol. % or 3.25 mol. % or 3.5 mol. % or 3.75 mol. % or 4 mol. % or 4.5 mol. % or 4.75 mol. % or 5 mol. % or 7.5 mol. % or 10 mol. % or 15 mol. % or 20 mol. % or 25 mol. % or 30 mol. % or 35 mol. % or 40 mol. % or 45 mol. % or 50 mol. % or 55 mol. % or 60 mol. % or 65 mol. % or 70 mol. % or 75 mol. % or 80 mol. % or 85 mol. % or 90 mol. % or 91 mol. % or 92 mol. % or 93 mol. % or 94 mol. % or 95 mol. % or 96 mol. % or 97 mol. % or 98 mol. % or 99 mol. % or 99.5 mol. % or 99.9 mol. %. In another embodiment of the present invention, the concentration of H₂S from said gas feed removed by said reactor and process is in the range of 0.000001 vol. % to 100 vol. %. Preferably, the concentration of H₂S from said gas feed removed by said reactor is in the range of 1-100 vol. % or 1-99.9 vol. % or 1.99.5 vol. % or 1-99 vol. % or 2-98 vol. % or 3-97 vol. % or 4-96 vol. % or 5-95 vol. % or 10-90 vol. % or 15-85 vol. % or 20-80 vol. % or 25-75 vol. % or 30-70 vol. % or 35-65 vol. % or 40-60 vol. % or 45-55 vol. %.

More specifically, the concentration of H₂S from said gas feed removed by said reactor is 0.00001 vol. % or 0.0001 vol. % or 0.001 vol. % or 0.01 vol. % or 0.1 vol. % or 1 vol. % or 1.25 vol. % or 1.5 vol. % or 2 vol. % or 2.5 vol. % or 2.75 vol. % or 3 vol. % or 3.25 vol. % or 3.5 vol. % or 3.75 vol. % or 4 vol. % or 4.5 vol. % or 4.75 vol. % or 5 vol. % or 7.5 vol. % or 10 vol. % or 15 vol. % or 20 vol. % or 25 vol. % or 30 vol. % or 35 vol. % or 40 vol. % or 45 vol. % or 50 vol. % or 55 vol. % or 60 vol. % or 65 vol. % or 70 vol. % or 75 vol. % or 80 vol. % or 85 vol. % or 90 vol. % or 91 vol. % or 92 vol. % or 93 vol. % or 94 vol. % or 95 vol. % or 96 vol. % or 97 vol. % or 98 vol. % or 99 vol. % or 99.5 vol. % or 99.9 vol. %.

In another embodiment of the present invention, the metal catalyst is iron di carboxylic acid in aqueous solution.

In another embodiment of the present invention, the concentration of iron di carboxylic acid catalyst in said catalyst bed(s) is in the range of 0.00001 mol. % to 99.99 mol. %.

Preferably, the concentration of iron malic acid catalyst in said catalyst bed(s) is in the range of 1-99 mol. % or 2-98 mol. % or 3-97 mol. % or 4-96 mol. % or 5-95 mol. % or 10-90 mol. % or 15-85 mol. % or 20-80 mol. % or 25-75 mol. % or 30-70 mol. % or 35-65 mol. % or 40-60 mol. % or 45-55 mol. %.

More specifically, the concentration of iron di carboxylic acid catalyst in said catalyst bed(s) is 0.0001 mol. % or 0.001 mol. % or 0.01 mol. % or 0.1 mol. % or 1 mol. % or 1.25 mol. % or 1.5 mol. % or 2 mol. % or 2.5 mol. % or 2.75 mol. % or 3 mol. % or 3.25 mol. % or 3.5 mol. % or 3.75 mol. % or 4 mol. % or 4.5 mol. % or 4.75 mol. % or 5 mol. % or 7.5 mol. % or 10 mol. % or 15 mol. % or 20 mol. % or 25 mol. % or 30 mol. % or 35 mol. % or 40 mol. % or 45 mol. % or 50 mol. % or 55 mol. % or 60 mol. % or 65 mol. % or 70 mol. % or 75 mol. % or 80 mol. % or 85 mol. % or 90 mol. % or 91 mol. % or 92 mol. % or 93 mol. % or 94 mol. % or 95 mol. % or 96 mol. % or 97 mol. % or 98 mol. % or 99 mol. % or 99.5 mol. % or 99.9 mol. %.

In another embodiment of the present invention, 0.1% to high up to 100% of H₂S is/can be removed by above process and reactor from feed/stream.

In another embodiment of the present invention, the flow rate of gases and liquids, H₂S concentration, and length of reactor (including compartments) are all variable depending upon requirement of processes such as type of reaction, higher scale production, etc.

In another embodiment of the present invention, the metal catalyst bed comprises a polyvalent metal chelatable in both oxidized and reduced states.

In another embodiment of the present invention, the polyvalent metal is selected from the group consisting of tin, lead, copper, manganese, platinum, tungsten, nickel, palladium, chromium, cobalt, vanadium, titanium, tantalum, zirconium, molybdenum or mixture thereof.

In another embodiment of the present invention, the carboxylic acid metal chelate is a transition metal chelate of iron selected from the group consisting of a solution of sulfates. nitrates, thiosulfates, chlorides, acetates, oxalates and phosphates.

In another embodiment of the present invention, the transition metal salt is chelated with a carboxylic acid.

In another embodiment of the present invention, the carboxylic acid is selected from the group consisting of mono-, di- and tri-carboxylic acids obtained from biodegradable sources.

In another embodiment of the present invention, the carboxylic acid is selected from the group consisting of succinic acid, citric acid, malic acid, gluconic acid and oxalic acid.

In another embodiment of the present invention, the inlet gas flow rate (130) in the first compartment (110) is in the range of 0.1 to 600000 ml/min.

Preferably, the inlet gas flow rate (130) in the first compartment (110) is in the range of 0.5 to 600000 ml/min, or 1 to 600000 ml/min, or 2.5 to 600000 ml/min, or 5 to 600000 ml/min. or 10 to 600000 ml/min, or 25 to 600000 ml/min, or 50 to 600000 ml/min, or 100 to 600000 ml/min, or 250 to 600000 ml/min, or 500 to 600000 ml/min, or 750 to 600000 ml/min. or 1000 to 600000 ml/min, or 1250 to 600000 ml/min, or 1500 to 600000 ml/min, or 1750 to 600000 ml/min, or 2000 to 600000 ml/min, or 2500 to 600000 ml/min, or 3000 to 600000 ml/min, or 4000 to 600000 ml/min, or 5000 to 600000 ml/min, or 10000 to 600000 ml/min. or 20000 to 600000 ml/min, or 50000 to 600000 ml/min, or 75000 to 600000 ml/min. or 100000 to 600000 ml/min, or 150000 to 600000 ml/min, or 200000 to 600000 ml/min. or 300000 to 600000 ml/min, or 400000 to 600000 ml/min, or 500000 to 600000 ml/min. or 100 to 6000 ml/min.

More preferably, the inlet biogas flow rate (130) in the first compartment (110) is 600 ml/min which may be operable in the range of 0-1600 ml/min.

In another embodiment of the present invention, the inlet air flow rate (140) in the second compartment (120) is 0 to 1000000 ml/min.

Preferably, the inlet air flow rate (140) in the second compartment (120) is 0.1 to 1000000 ml/min, or 0.5 to 1000000 ml/min, or 1 to 1000000 ml/min, or 2.5 to 1000000 ml/min, or 5 to 1000000 ml/min, or 10 to 1000000 ml/min, or 25 to 1000000 ml/min, or 50 to 1000000 ml/min, or 100 to 1000000 ml/min, or 250 to 1000000 ml/min, or 500 to 1000000 ml/min. or 750 to 1000000 ml/min, or 1000 to 1000000 ml/min, or 1250 to 1000000 ml/min, or 1500 to 1000000 ml/min, or 1750 to 1000000 ml/min, or 2000 to 1000000 ml/min, or 2500 to 1000000 ml/min, or 3000 to 1000000 ml/min, or 4000 to 1000000 ml/min, or 5000 to 1000000 ml/min, or 10000 to 1000000 ml/min, or 20000 to 1000000 ml/min, or 50000 to 1000000 ml/min, or 75000 to 1000000 ml/min, or 100000 to 1000000 ml/min, or 150000 to 1000000 ml/min, or 200000 to 1000000 ml/min, or 300000 to 1000000 ml/min, or 400000 to 1000000 ml/min, or 500000 to 1000000 ml/min, or 600000 to 1000000 ml/min, or 700000 to 1000000 ml/min, or 700000 to 1000000 ml/min, or 800000 to 1000000 ml/min, or 900000 to 1000000 ml/min, or 100 to 10000 ml/min.

More preferably, the inlet air flow rate (140) in the second compartment (120) is 1000 ml/min. The Spurger design helps for the optimum gas disruption inside the catalytic fluid pool.

In another embodiment of the present invention, the reactor used is a bubbler column reactor. The bubbler column reactor used in the present invention is a continuous counter-cross current flow slurry reactor for the efficient removal of H₂S from the flowing fluid stream. Multi step approach as proposed in this design helps for the remixing of the gas stream which improves the gas-liquid interactions and thus the reactor can handle a wide range of H₂S load. The counter-cross current flow geometry helps to achieve desired mass transfer.

In another embodiment of the present invention, the H₂S gas in presence of other gases like ammonia, etc. can also be possible to remove by above mentioned reactor and process.

In said reactor, multiple horizontal groove like arrangements are provided for residing gas micro bubbles, which react with vertical flow of catalyst containing stream or feed; wherein said horizontal arrangement(s) are in the same length to have efficient retention time of feed to react with catalyst. Further, it is noted that due to said groove-like horizontal arrangements in said reactor, the residence time is higher, back mixing and subsequent collapse of the gas bubbles offers appropriate mass transfer rate better than conventional/known reactors. Also, the back pressure is higher due to said arrangements, which makes the contact between feed and catalyst efficient along with flow.

In another embodiment of the present invention, the catalyst can be regenerated in-situ with air flow so catalyst durability is high. The metal catalyst can be readily activated with the help of air without using any energy for the activation. The continuous activation of the catalyst without using any energy makes the process durable for long hour operations. Thus, the new reactor design makes it possible for continuous H₂S removal as well as catalyst regeneration and solid sulphur separation.

In an embodiment, the present invention relates to a continuous process for catalytic removal of H₂S gas along with production of solid sulphur using said reactor comprising treating and reacting feed/stream containing H₂S as byproduct with metal catalyst solution present in said reactor to obtain feed with metal sulphides which is subsequently treated with oxygen/air to separate out H₂S as gas and solid sulphur in spent stream.

In another embodiment of the present invention, the feed/stream containing H₂S is selected from biogas, coal gas product/feeds, steel industry feeds and crude oil. Further the H₂S gas in presence of other gases like ammonia gas can be removed by the above mentioned reactor and process.

In another embodiment of the present invention, the catalyst consists of metal selected from transition metal and alkaline metal precursors. The metal is selected from the group consisting of iron, tin, lead, copper, manganese, platinum, tungsten, nickel, palladium, chromium, cobalt, vanadium, titanium, tantalum, zirconium and molybdenum.

In another embodiment of the present invention, the metal catalyst solution is a metal chelate catalyst in an aqueous solution. The catalyst solution is maintained at the pH of 7.0 to 9.0 using a hydroxide of an alkaline earth element selected from the group consisting of Na. K and Mg. The pH of the solution is adjusted to 7-7.5 by addition of the NaOH solution.

In another embodiment of the present invention, the metal chelate is a transition metal chelate of iron selected from the group consisting of a solution of sulfates, nitrates, thiosulfates, chlorides, acetates, oxalates and phosphates. The transition metal salt is chelated with a di-carboxylic acid. The di-carboxylic acid is selected from the group consisting of succinic acid, malic acid, gluconic acid and oxalic acid. Further, the iron chelate catalyst has dicarboxylic acid as chelating agent, wherein the ratio of dicarboxylic acid:Fe is 3:1.

In another embodiment, the dicarboxylic acid is selected from but not limited to malic acid.

In another embodiment of the present invention, the process provides the flexibility of varying concentrations, wherein the metal catalyst concentration is in the range of 0.00001% to 99.999%. for the H₂S removal and this concentration can be selected depending on feed H₂S concentrations. Further, the feed containing H₂S concentration to be converted is in the range 0.000001% to 100%. Thus, this type of catalytically driven H₂S removal system can handle multiple feeds from various sources.

In another embodiment of the present invention, the oxygen source is selected from air and molecular oxygen.

In another embodiment of the present invention, the catalyst composition is highly active and can remove 9 moles of sulphur per mole of catalyst. This reaction happens spontaneously inside the reactor at atmospheric conditions and the catalyst reactivation also can be done in-situ by using milder oxidation conditions.

In another embodiment of the present invention, the temperature is in the range of 25 °C to 80 °C.

In another embodiment of the present invention, the removal of H₂S gas happens due to a displacement reaction which is a spontaneous reaction and need not to supply any form of energy. The wt. of H₂S removed/wt. of catalyst loaded ratio is more for the process as it offers a continuous regeneration approach. Thus, the H₂S removal by catalytic reaction makes this process more flexible and adaptable for continuous operation as well as scale up.

In another embodiment, the present invention provides a process which is cost effective, easy to handle, high throughput, highly selective, safe and environment friendly.

The inventors of the present application developed and designed an apparatus and a process involving the use of a novel multi step-multi phase co/counter cross current slurry reactor for the efficient removal of H₂S from the flowing fluid stream. The process provides the flexibility of varying concentrations from 0.000001% to 100% for the H₂S removal and said concentrations can be selected depending on feed H₂S concentrations. It clearly indicates that this type of catalytically driven H₂S removal system can handle multiple feeds from various sources.

The catalyst composition is highly active and can remove 9 moles of sulphur per mole of catalyst, and this reaction happens to be spontaneously done inside the reactor at atmospheric conditions. More importantly, the catalyst reactivation also can be done in an in-situ method by using milder oxidation conditions.

While the foregoing describes various embodiments of the disclosure, other and further embodiments of the disclosure may be devised without departing from the basic scope thereof. The invention is not limited to the described embodiments, versions or examples, which are included to enable a person having ordinary skill in the art to make and use the invention when combined with information and knowledge available to the person having ordinary skill in the art.

### EXAMPLES

The present invention is further explained in the form of the following examples. However, it is to be understood that the following examples are merely illustrative and are not to be taken as limitations upon the scope of the invention.

### Example 1—Catalyst Synthesis

The catalyst was prepared by previously reported procedure (Nanoscale Res Lett, Vol. 3, P. 221-229, 2008) by dissolving ferric chloride salt (162 g, 1 mol) into 500 ml water. The malic acid (MA) (402 g, 3 mol) dissolved in 1000 ml was added to the iron chloride solutions. The solution was stirred for 2 h at room temperature. The pH of the solution was adjusted to 7-7.5 by addition of the 5N NaOH solution. The final solution was diluted to 5.6 lit to get 1% concentration of iron (III). The catalyst solution was used for H₂S removal after diluting with water to get the required concentration of Fe(III) depending on the H₂S concentration in the gas stream to be treated for H₂S removal.

### Example 2—H₂S Removal Using Batch Mode of Operation without Multi Step Slurry Reactor

The catalyst slurry solution was made using distilled water and catalyst concentration was maintained at 117 ppm. 1 liter of 117 ppm catalyst solution was taken into the batch glass column reactor. The reactor was equipped with bottom gas entry through 0.1 micron pore size gas distributor. The feed gas with the flow rate of 50 ml/min was passed into the catalyst slurry and the outlet of the reactor was monitored using an online H₂S analyzer. The inlet H₂S contain was observed at 110 ppm whereas the outlet H₂S contain was noted as 0.1 ppm. The experiment was continued until H₂S slippage was observed and after 7 min H₂S started increasing at the reactor outlet so gas inlet was stopped after 7 min as shown in table 1.

TABLE 1

| Catalyst | 0.117 | Gm |
|---|---|---|
| Gas flow | 50 | ml/min |
| H₂S in raw gas | 110 | Ppm |
| Time on stream (TOS) | Min | |
| Total gas in | 0.35 | Lit |
| Total H₂S in | 0.0385 | Gm |

| | |
|---|---|
| Grams of H₂S removed per | 0.32906 |
| gram catalyst in one cycle | |

### Example 3—H₂S Removal Using Continuous Mode of Operation with Multi Step Counter-Cross Current Slurry Flow Reactor

The catalyst solution was made by diluting the solution as in Example 1 above to get Fe concentration of 0.1%, 2 liters of 0.1% Fe(III) catalyst solution was taken into the continuous counter-cross current flow slurry reactor. The reactor was equipped with bottom gas entry through a 0.1-micron pore size gas distributor. The reactor is provided with an in-situ catalyst regeneration mechanism. The raw gas inlet was maintained at 600 ml/min. The raw gas and reactor outlet was monitored using an online H₂S analyzer. With the continuous approach and multi-step counter cross current flow slurry reactor, the removal efficiency and capacity improved as shown in table 2.

### Results:—

TABLE 2

| Catalyst (Fe) | 0.1% | |
|---|---|---|
| Total Solution prepared | 2000 | ml |
| Total Catalyst (Fe) Used | 2 | Grams |
| Biogas H₂S | 650 | ppm |
| Inlet gas flow | 600 | ml/min |
| Total Time On Stream | 7 | Hr |
| Total Gas In | 252 | Lit |
| Total H₂S In | 163.8 | Gm |
| H₂S Removal efficiency | 99.85% | |
| *Grams of H₂S removed per | 81.9 | |
| gram of Fe in catalyst | | |
| #Solid sulfur obtained | 150 | Grams |
| as yellow powder | | |

*Said value is calculated based on amount of feed containing H2S (as supplied) minus the amount of H2S from H2S free gas obtained from 1^{st} compartment of the reactor.
#The solid sulfur obtained has purity >99% with crystalline nature and larger particles of 0.1 μm to 10 μm. The sulfur formation was also confirmed by FTIR analysis.

### Example 4—H₂S Removal Using Continuous Mode of Operation with Multi Step Counter-Cross Current Slurry Flow Reactor

The catalyst solution was made by diluting the solution as in Example 1 above to get Fe concentration of 2.4%, 150 liters of 2.4% Fe(III) catalyst solution was taken into the continuous counter-cross current flow slurry reactor. The reactor was equipped with bottom gas entry through a 0.1-micron pore size gas distributor. The reactor is provided with an in-situ catalyst regeneration mechanism by oxidation in presence of air/oxygen in 2^{nd} compartment of the reactor. The raw gas inlet was maintained at 50 lit/min. The raw gas and reactor outlet was monitored using an online H₂S analyzer. With the continuous approach and multi-step counter cross current flow slurry reactor, the removal efficiency and capacity improved as shown in table 3.

### Results:—

TABLE 3

| Catalyst (Fe) | 2.4% | |
|---|---|---|
| Total Solution prepared | 150 | lit |
| Total Catalyst (Fe) Used | 3600 | Grams |
| Biogas H₂S | 20000 | ppm |
| Inlet gas flow | 50 | lit/min |
| Total Time On Stream | 4 | Hr |
| Total Gas In | 12000 | Lit |
| Total H₂S In | 240.0 | Kg |
| H₂S Removal efficiency | 99.5% | |
| Grams of H₂S removed per | 66.7 | |
| gram of Fe in catalyst | | |
| #Solid sulfur obtained | 220 | Kg |

as yellow powder

*Said value is calculated based on amount of feed containing H2S (as supplied) minus the amount of H2S from H2S free gas obtained from 1^{st} compartment of the reactor.
#The solid sulfur obtained has purity >99% with crystalline nature and larger particles of 0.1 μm to 10 μm. The sulfur formation was also confirmed by FTIR analysis.

A skilled artisan will appreciate that the quantity and each of the ingredients can be used in different combinations or singly. All such variations and combinations would be falling within the scope of present disclosure.

The foregoing examples are merely illustrative and are not to be taken as limitations upon the scope of the invention. Various changes and modifications to the disclosed embodiments will be apparent to those skilled in the art. Such changes and modifications may be made without departing from the scope of the invention.

### ADVANTAGES OF THE PRESENT INVENTION

1) The present invention provides an apparatus/reactor for an effective and continuous catalytic separation of H₂S gas and subsequently production of sulphur.
2) The present invention provides the novel catalyst composition that has high selectivity for the H₂S gas separation, without using any source of energy for the reaction.
3) The present invention provides a process which is cost effective, wherein the operation cost, catalyst cost and reactivation cost are low.
4) The present invention provides a process which performs 4 times better than batch process.
5) The present invention provides a process which is easy to handle, high throughput, safe and environment friendly.
6) The present invention provides a catalyst that can be regenerated in-situ with air flow hence catalyst durability is higher.
7) The present invention provides use of a multi-step counter-cross current slurry reactor which provides required gas retention time inside the pool of catalyst solution, and helps to achieve desired mass transfer.
8) The present invention provides a multi-step approach as proposed in this design which helps for the remixing of the gas stream which improves the gas-liquid interactions and thus the reactor can handle a wide range of H₂S load.
9) The present invention provides a circulation pump that is selected in such a way that it provides optimum liquid retention time inside the reactor as well as a regeneration column.
10) The present invention provides a process that is designed for the continuous removal of elemental sulphur.
11) The present invention provides the concentrations of catalyst solution/slurry which can vary as per the inlet feed H₂S concentration as a wide range of catalyst slurry/solutions can be used i.e. (0.01% to 99.99%).

1. A reactor system for separation of H₂S gas and subsequent production of sulphur from feed or stream containing mixture of gases and H₂S, wherein the reactor system comprises:
a) a first compartment comprises an inlet gas feed flow containing the feed/stream, and plurality of horizontal grooves with metal catalyst beds, to react H₂S gas of the feed/stream with the metal catalyst to obtain H₂S free gas stream, and a metal sulfide;
b) the first compartment is connected to a second compartment for passing and treating the metal sulphide with air/oxygen in the second compartment to obtain solid sulphur and spent catalyst; wherein the second compartment comprises an inlet air flow;
c) filter press or gravity separation unit connected with the second compartment in order to separate the obtained solid sulphur; and
d) optionally the spent catalyst is fed back into the first compartment from second compartment via the filter press or gravity separation unit.

2. The reactor system as claimed in claim 1, wherein the H₂S free gas stream is removed from a top side of the first compartment; wherein the first and second compartments have a length in the range of 0.1 to 2000 cm, and a diameter in the range of 0.01 to 110 cm.

3. The reactor system as claimed in claim 1, wherein the horizontal grooves are placed horizontally in a vertical shaped first compartment with an angle in the range of 60° to 90°.

4. The reactor system as claimed in claim 1, wherein a rate of the inlet gas flow containing mixture of gases into the first compartment is in the range of 0.1 to 600000 ml/min; and wherein a rate of the inlet air flow into the second compartment is in the range of 0.1 to 1000000 ml/min.

5. The reactor system as claimed in claim 1, wherein the first compartment and second compartment are same or different, and are selected from a multi-phase co/counter current slurry flow reactor, a bubble column reactor, a slurry flow co/counter current multiphase reactor, a cascaded bubble column reactor, and a batch reactor.

6. A continuous process for the separation of H₂S gas and subsequent production of sulphur from feed or stream containing mixture of gases and H₂S, the process comprising:
i. passing the feed/stream via an inlet gas feed flow into a first compartment for treating and reacting with a metal catalyst to obtain H₂S free gas stream, and a metal sulfide, wherein the metal catalyst is placed on plurality of horizontal grooves beds in the first compartment;
ii. passing and treating the metal sulphide with air/oxygen in a second compartment to obtain solid sulphur and spent catalyst followed by separating the obtained solid sulfur from filter press or gravity separation unit connected with the second compartment; and
iii. optionally feeding back the spent catalyst into the first compartment from second compartment via the filter press or gravity separation unit.

7. The reactor system as claimed in claim 1, wherein the feed/stream containing H₂S is selected from biogas, coal gas product/feeds, steel industry feeds and crude oil.

8. The reactor system as claimed in claim 1, wherein the catalyst consists of a metal selected from transition metal and alkaline metal precursors.

9. The reactor system as claimed in claim 1, wherein the metal in the metal catalyst is selected from iron, tin, lead, copper, manganese, platinum, tungsten, nickel, palladium, chromium, cobalt, vanadium, titanium, tantalum, zirconium, molybdenum, or mixtures thereof.

10. The process as claimed in claim 6, wherein the metal catalyst present in the first compartment is in an aqueous catalyst solution maintained at pH in the range of 7.0 to 9.0 by adding a hydroxide of an alkaline earth element selected from the group consisting of sodium, potassium, and magnesium.

11. The process as claimed in claim 10, wherein the metal catalyst solution comprises a metal chelate catalyst in an aqueous solution, wherein the metal chelate is a transition metal salt of iron selected from the group consisting of a solution of sulfates, nitrates, thiosulfates, chlorides, acetates, oxalates and phosphates.

12. The process as claimed in claim 10, wherein the transition metal salt is chelated with di carboxylic acid, wherein the di-carboxylic acid is selected from succinic acid, malic acid, gluconic acid and oxalic acid.

13. The process as claimed in claim 6, wherein a concentration of the metal catalyst is in the range of 0.00001 mol. % to 50 mol. %; wherein a concentration of H₂S obtained from the feed/stream containing mixture of gases and H₂S as byproduct is in the range of 0.000001 vol. % to 100 vol. %; and wherein a temperature of the reactor is kept in the range of 25 °C to 80 °C.
